(19) United States
(12) Patent Application Publication
(10) Pub. No.: US 2026/0017563 A1
(43) Pub. Date: Jan. 15, 2026

(54) PREDICTING SYSTEM AND METHOD FOR DISTRIBUTION ANOMALY PREDICTION FOR NEW MINERAL EXPLORATION USING MINERALOGICAL UNDERSTANDING AND ARTIFICIAL INTELLIGENCE ANALYSIS OF GEOCHEMICAL DATA

(71) Applicant: Korea Institute Of Geoscience And Mineral Resources, Daejeon (KR)

(72) Inventors: Pyeong Koo LEE, Daejeon (KR); Sang-Gi HWANG, Daejeon (KR); Jeong-Ho LEE, Daegu (KR); Seong-Cheon SHIN, Daejeon (KR); Seung-Jun YOUM, Daejeon (KR)

(73) Assignee: Korea Institute Of Geoscience And Mineral Resources, Daejeon (KR)

(21) Appl. No.: 18/939,862

(22) Filed: Nov. 7, 2024

(30) Foreign Application Priority Data
Jul. 9, 2024 (KR) 10-2024-0090656

(51) Int. Cl. G06N 20/00; G01V 20/00; G06F 16/29

(52) U.S. Cl. CPC G06N 20/00; G01V 20/00; G06F 16/29

(57) ABSTRACT

A system and method for distribution anomaly prediction for new mineral exploration using mineralogical understanding and artificial intelligence analysis of geochemical data are provided, the system comprising: a database development unit configured to collect regional distribution data including pre-collected geochemical data and geologic spatial data of a region and to integrate map data and data set to construct integrated data into a database; a model learning unit configured to generate and learn an exploration mineral distribution anomaly model based on machine learning, wherein the exploration mineral distribution anomaly model enables prediction of distribution anomaly based on geologic and ore deposit geological understanding of exploration mineral using the integrated data; and a distribution anomaly prediction unit configured to predict the distribution anomaly of the exploration minerals in an exploration region using the learned exploration mineral distribution anomaly model.

### CROSS-REFERENCE TO RELATED APPLICATION

This application claims priority to Korean Patent Application No. 10-2024-0090656 filed on Jul. 9, 2024, and all the benefits accruing therefrom under 35 U.S.C. § 119, the contents of which is incorporated by reference in its entirety.

### BACKGROUND OF THE DISCLOSURE

### 1. Field of the Disclosure

The present disclosure relates to a system and a method for predicting distribution anomaly of exploration minerals. In particular, the present disclosure relates to a system and a method for distribution anomaly prediction for new mineral exploration using mineralogical understanding and artificial intelligence analysis of geochemical data, which can significantly increase the probability of successful mineral discovery and extraction.

### 2. Description of the Related Art

In the era of global carbon neutrality policy, the utilization and importance of lithium batteries as an eco-friendly energy source is increasing. Therefore, securing rare earth resources such as lithium and developing exploration technologies are becoming important issues.

In particular, specific exploration techniques limited to specific minerals are applied to the explorations of ore deposits with effective minerals, in consideration of the situations of ore deposit genesis and embedment. Due to the rapid development of data mining techniques and the expansion of their application fields in recent years, there is a growing demand for the development of new exploration systems and methods by utilizing materials that have not been widely used in conventional explorations, e.g., geochemical data.

In addition, as the resource development business has the nature of high-risk and high-return, it is essential to develop resource exploration technology utilizing advanced technology to mitigate risks. Moreover, there are demands for the systems and methods that can dramatically mitigate the high-risk and compensate the shortcomings of traditional exploration techniques, by incorporating artificial intelligence (AI) technologies that provide insight, speed, and accuracy.

### RELATED PATENT DOCUMENT

Korean Registered Patent No. 10-1979936 (May 21, 2019)
Korean Patent Publication No. 10-2018-0055518 (May 25, 2018)

### SUMMARY OF THE DISCLOSURE

The purpose of the present disclosure, which aims to solve the aforementioned conventional problems, is to provide a system and method for distribution anomaly prediction for new mineral exploration using mineralogical understanding and artificial intelligence analysis of geochemical data. The system and method can increase the efficiency and reduce the cost of mineral exploration, as well as support more sustainable practices, provide deeper geological insights, and significantly increase the probability of successful mineral discovery and extraction.

In addition, the purpose of the present disclosure is to develop AI models of locations where mineral deposits have been identified and where the mineral deposits have not identified, based on geochemical data analyzed from bedrocks or stream sediments, by adding regional distributions such as geologic maps, geologic structure maps, topographic elevations, elastic waves, radioactive exploration data, and the like.

In addition, the purpose of the present disclosure is to provide a system and method for predicting the viability of the mineral deposits (e.g., lithium-containing pegmatite) or distribution anomaly of the exploration minerals, by inputting integrated data sets incorporating geochemical data and regional data of the locations to be explored into the developed AI model.

In order to achieve the purpose, an aspect of the present disclosure provides system for distribution anomaly prediction for new mineral exploration using mineralogical understanding and artificial intelligence analysis of geochemical data, the system comprising: a database development unit configured to collect regional distribution data including pre-collected geochemical data and geologic spatial data of a region and to integrate map data and data set to construct integrated data into a database; a model learning unit configured to generate and learn an exploration mineral distribution anomaly model based on machine learning, wherein the exploration mineral distribution anomaly model enables prediction of distribution anomaly based on geologic and ore deposit geological understanding of exploration mineral using the integrated data; and a distribution anomaly prediction unit configured to predict the distribution anomaly of the exploration minerals in an exploration region using the learned exploration mineral distribution anomaly model.

In some exemplary embodiments, the geologic spatial data may include at least one of raster topographic analysis information, raster and vector data extracted grid information, fault buffer map information, large classification geologic map information, potential embedment medium buffer map information of exploration mineral, or a combination thereof.

In some exemplary embodiments, the database development unit includes: a data collection unit configured to collect regional distribution data including pre-collected geochemical data, geologic spatial data and physical exploration data of a region; a data process unit configured to digitalize the geochemical data, the geologic spatial data and the physical exploration data; a mapping unit configured to map geologic and geochemical characteristics based on the geochemical data and the geologic spatial data using a geographic information system (GIS); an integration unit configured to generate integrated data by integrating map data and data set; and a database configured to store the integrated data.

In some exemplary embodiments, the model learning unit may include: a correlation analysis unit configured to extract correlation information with the exploration mineral from the integrated data by statistical analysis; a preprocess unit configured to generate and preprocess model learning data based on the integrated data and the correlation information; and a learning unit configured to learn an exploration mineral distribution anomaly model for predicting distribution anomaly of the exploration mineral using the model learning data.

In addition, in order to achieve the purpose, another aspect of the present disclosure provides a method for distribution anomaly prediction for new mineral exploration using mineralogical understanding and artificial intelligence analysis of geochemical data, the method comprising steps of: (a) collecting regional distribution data including pre-collected geochemical data and geologic spatial data of a region; (b) mapping the geochemical data and the geologic spatial data, and integrating map data and data set to construct integrated data into a database; (c) generating and learning an exploration mineral distribution anomaly model based on machine learning, wherein the exploration mineral distribution anomaly model enables prediction of distribution anomaly based on geologic and ore deposit geological understanding of exploration mineral using the integrated data; and (d) predicting distribution of an exploration minerals in the exploration region using the learned exploration mineral distribution anomaly model.

In some exemplary embodiments, the geochemical data may include geochemical data of at least one of Al₂O₃, SiO₂, Fe₂O₃, CaO, Na₂O, K₂O, MgO, P₂O₅, MnO, TiO₂, Ba, Cu, Li, Ni, Pb, Sr, V, Zr, Co, Cr, Rb, Zn, Ce, Cs, Sc, Eu, Yb, Th, Hf, or a combination thereof, as components of a stream sediment.

In some exemplary embodiments, the geologic spatial data may include at least one of raster topographic analysis information, raster and vector data extracted grid information, fault buffer map information, large classification geologic map information, potential embedment medium buffer map information of exploration mineral, or a combination thereof.

In some exemplary embodiments, the step (b) includes steps of: (b1) digitalizing the geochemical data and the geologic spatial data; (b2) mapping geologic and geochemical characteristics based on the geochemical data and the geologic spatial data using a geographic information system (GIS); and (b3) constructing integrated data into a database by integrating map data and data set.

In some exemplary embodiments, the step (c) may include steps of: (c1) extracting correlation information with the exploration mineral from the integrated data by statistical analysis; (c2) generating and preprocessing model learning data based on the integrated data and the correlation information; and (c3) learning an exploration mineral distribution anomaly model for predicting distribution anomaly of the exploration mineral using the model learning data.

In some exemplary embodiments, the integrated data may include a geochemical threshold value calculated from the geochemical data by a method of statistical outlier extraction.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

The present disclosure provides a system and method for distribution anomaly prediction for new mineral exploration using mineralogical understanding and artificial intelligence analysis of geochemical data. The system and method can increase the efficiency and reduce the cost of mineral exploration, as well as support more sustainable practices, provide deeper geological insights, and significantly increase the probability of successful mineral discovery and extraction.

In addition, according to an exemplary embodiment of the present disclosure, the integration of geochemical data and mineralogical insights allows for more accurate prediction of mineral deposit locations, as well as more targeted exploration. This reduces the area that needs to be physically surveyed, thus minimizing the cost and time to discovery.

Furthermore, according to an exemplary embodiment of the present disclosure, by using predictive models based on geochemical and mineralogical data, resources can be allocated more efficiently, resulting in greater cost-effectiveness in that efforts and investments can be focused on areas that are more likely to contain economically viable mineral deposits.

Furthermore, according to an exemplary embodiment of the present disclosure, by reducing the extent and intensity of ground disturbance, which is particularly important in ecologically sensitive or protected areas, exploration companies can better comply with environmental regulations and protect biodiversity.

Furthermore, according to an exemplary embodiment of the present disclosure, the systems that integrate geochemical data and mineralogical understanding can provide deeper insights into geologic processes underway in a given region.

In addition, the system and method according to an exemplary embodiment of the present disclosure can also help guide further exploration and assess mining potential and risks by providing a comprehensive understanding of the site's geologic history, including rock formation, alteration, and erosion processes, as well as the presence of specific minerals.

Further, according to an exemplary embodiment of the present disclosure, the use of AI and machine learning algorithms provides the potential to identify patterns and correlations that may be invisible to human analysts. Moreover, the use of AI and machine learning algorithms can process vast amounts of data quickly and precisely, and can continuously learn and improve with additional data inputs to improve predictive models over time to increase predictive accuracy.

In addition, according to an exemplary embodiment of the present disclosure, multiple data sources can be integrated, including geochemical and mineralogical data, as well as physical exploration data such as seismic and radiometric data, and spatial data from a geographic information system (GIS) platform to increase the stability and reliability of the model.

### BRIEF DESCRIPTION OF THE DRAWINGS

FIG. 1 is a block diagram illustrating a system for distribution anomaly prediction for new mineral exploration using mineralogical understanding and artificial intelligence analysis of geochemical data according to an exemplary embodiment of the present disclosure.

FIG. 2 is a flow chart illustrating a method for distribution anomaly prediction for new mineral exploration using mineralogical understanding and artificial intelligence analysis of geochemical data according to an exemplary embodiment of the present disclosure.

FIG. 3 is a map of sampling points of stream sediments and major water systems that are applied to a system for distribution anomaly prediction for new mineral exploration using mineralogical understanding and artificial intelligence analysis of geochemical data according to an exemplary embodiment of the present disclosure.

FIG. 4 is a large category geologic map applied to a system for distribution anomaly prediction for new mineral exploration using mineralogical understanding and artificial intelligence analysis of geochemical data according to an exemplary embodiment of the present disclosure.

FIG. 5 is a pegmatite derivation and buffer map applied to a system for distribution anomaly prediction for new mineral exploration using mineralogical understanding and artificial intelligence analysis of geochemical data according to an exemplary embodiment of the present disclosure.

FIG. 6 is a derivation diagram of geochemical threshold values applied to a system for distribution anomaly prediction for new mineral exploration using mineralogical understanding and artificial intelligence analysis of geochemical data according to an exemplary embodiment of the present disclosure.

FIG. 7 is a graph illustrating principal component analysis (PCA) of geochemical data applied to a system for distribution anomaly prediction for new mineral exploration using mineralogical understanding and artificial intelligence analysis of geochemical data according to an exemplary embodiment of the present disclosure.

FIG. 8 is a diagram illustrating predictive modeling and validation process for lithium anomalies of pegmatite origin applied to a system for distribution anomaly prediction for new mineral exploration using mineralogical understanding and artificial intelligence analysis of geochemical data according to an exemplary embodiment of the present disclosure.

FIG. 9 and FIG. 10 are graphs illustrating results of the predictive modeling and validation process for lithium anomalies of pegmatite origin applied to a system for distribution anomaly prediction for new mineral exploration using mineralogical understanding and artificial intelligence analysis of geochemical data according to an exemplary embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Moreover, one or more “unit” described in this specification can be implemented via a non-transitory memory (not shown) and a processor (not shown). The memory is configured to store data concerning algorithms designed to control the operation of system components according to exemplary embodiments of the present invention, or software instructions that implement these algorithms. The processor is configured to perform the operations described below using the data stored in the memory. Here, the memory and the processor may be implemented as separate chips. Alternatively, the memory and the processor may be implemented as a single integrated chip. The processor may take the form of one or more processors.

As will be understood by those skilled in the art, the realization of all or some of the steps of the above embodiments may be accomplished through hardware, or may be accomplished by directing the relevant hardware through a computer program. The computer program may include instructions for executing some or all of the steps of the method, the computer program may be stored on a readable storage medium, and the storage medium may be any form of storage medium.

For example, each module, unit, sub-unit, or sub-module may be one or more integrated circuits configured to realize the above methods, such as one or more Application Specific Integrated Circuits (ASICs), one or more digital signal processors (DSPs), one or more Field Programmable Gate Arrays (FPGAs), or the like. In another example, where any of the above modules is realized in the form of scheduling program code in a processing element, the processing element may be a general purpose processor, such as a Central Processing Unit (CPU) or other processor capable of invoking program code. Alternatively, for example, these modules may be integrated together and realized in the form of a system-on-a-chip (SOC).

Hereinafter, exemplary embodiments of the present disclosure will be described in detail with reference to related drawings.

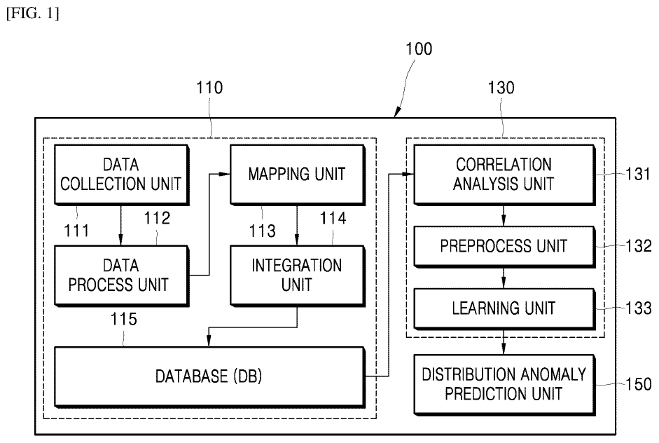

FIG. 1 is a block diagram illustrating a system 100 for distribution anomaly prediction for new mineral exploration using mineralogical understanding and artificial intelligence analysis of geochemical data according to an exemplary embodiment of the present disclosure.

As illustrated in FIG. 1, the distribution anomaly prediction system 100 for new mineral exploration using mineralogical understanding and artificial intelligence analysis of geochemical data according to an exemplary embodiment of the present disclosure may include a database development unit 110, a model learning unit 130 and a distribution anomaly prediction unit 150.

The database development unit 110 may be configured to collect regional distribution data including pre-collected geochemical data and geologic spatial data of a region and to integrate map data and data set to construct integrated data into a database.

The pre-collected geochemical data of the region may include geochemical data of at least one of Al₂O₃, SiO₂, Fe₂O₃, CaO, Na₂O, K₂O, MgO, P₂O₅, MnO, TiO₂, Ba, Cu, Li, Ni, Pb, Sr, V, Zr, Co, Cr, Rb, Zn, Ce, Cs, Sc, Eu, Yb, Th, Hf, or a combination thereof, as components of a stream sediment.

As described above, the comprehensive geochemical data set of 29 elements collected from inland stream sediments can provide a rich source of information for building predictive models to identify mineral deposits.

In addition, geochemical data of stream sediments excluding anthropogenic contamination may contain geologic information, and may show characteristic geochemical patterns in respect to the geologic information.

The advantages of geochemical data of stream sediments over geophysical surveys are as follows:

First, unlike geophysical surveys, which are indirect data-based estimates of targets, the geochemical data of stream sediments can detect the constituents of targets, allowing for direct detection of targets.

Second, the geochemical data of stream sediments can detect small-scale, important targets that may not be detected in broad-scale physical surveys.

In addition, the statistical summaries and distributions help to understand the geochemical landscape and, when combined with AI and machine learning techniques, can greatly improve the efficiency and accuracy of mineral exploration operations.

To be more specific, the database development unit 110 may includes a data collection unit 111, a data process unit 112, a mapping unit 113, an integration unit 114 and a database 115.

The data collection unit 111 may be configured to collect regional distribution data including pre-collected geochemical data, geologic spatial data and physical exploration data of a region

Here, the geologic spatial data may include at least one of raster topographic analysis information, raster and vector data extracted grid information, fault buffer map information, large classification geologic map information, potential embedment medium buffer map information of exploration mineral, or a combination thereof.

According to an exemplary embodiment of the present disclosure, the spatial data can be built for linkage analysis of stream sediment geochemical data with geological and mineralogical factors, in order to build machine learning training data based on geologic and ore deposit geological understanding (e.g., build a large classification geologic map in which lithofacies are simplified, build a fault and pegmatite derivation and buffer map, build a ore deposit location derivation and distribution map, etc.).

In addition, the geologic spatial data as described above can be used to obtain correlation analysis information to predict the distribution of exploration minerals, by using data as follows:
1) Creating a geochemical map (29 elements, IDW): a map can be created by using the geochemical data to analyze the 29 elements found in the stream sediments.

The inverse distance weighting (IDW) is a spatial interpolation method used in the geographic information system (GIS) that assigns values to unknown points based on the values of known points nearby, weighted inversely by distance. The result is a raster-based geochemical map, which can provide a continuous surface of elemental concentrations across the research region.
2) Using raster topographic analysis information: The analysis of digital elevation model (DEM) or other raster-based (grid-based) data representing topography elevation. The analysis may include identifying the geochemical characteristics of stream sediments by determining slope, aspect, elevation, and other topographical features that can affect weathering, erosion, and deposition of rocks.
3) Creating a grid for raster and vector data extraction: Setting up a structured grid (in raster or vector format) to systematically extract and analyze geochemical and geographic data for the area. This grid ensures consistent sampling and analysis across multiple locations, allowing determination of accurate spatial correlation.
4) Mapping a fault buffer map (1:250,000): The fault buffer map is a map centered on identified geologic faults and created at a scale of 1:250,000. The buffer (the area around the fault) can be analyzed, because faults can affect the mineralization process by acting as a conduit for mineral-bearing fluids or by creating structural traps.
5) Create a large category geologic map (simplifying hundreds of lithofacies units in the geologic map into 17 lithofacies): The geologic maps at a scale of 1:250,000 can simplify the lithofacies units by reducing the complex rock types to just 17 lithofacies. Such simplification can help the analysis to focus on the minerals desired to be explored, for example, the important rock types relevant to understanding lithium deposition properties.
6) Creating a potential embedment medium buffer map of exploration minerals (deriving pegmatite and related lithofacies polygons from 1:50,000 geologic maps and creating a buffer map): According to an exemplary embodiment of the present disclosure, a buffer map may be created centered on pegmatite and related lithofacies units at a more detailed scale of 1:50,000.

Pegmatites are important because they often contain significant concentrations of lithium-containing minerals. The buffer zone can be analyzed to capture the geochemical halo around the pegmatite, which may indicate a broader area affected by lithium mineralization.

As described above, the detailed geological and geochemical data can be integrated into a format that can be easily analyzed using machine learning techniques to predict regions likely to host lithium anomalies. This approach effectively combines geologic mapping with advanced spatial and statistical analysis to improve the precision of mineral exploration.

The physical exploration data may include at least one of elastic wave exploration data, radioactive exploration data, electrical exploration data, gravity exploration data, magnetic exploration data, which are collected from the site, or a combination thereof.

In other words, the distribution anomaly prediction system 100 for new mineral exploration using mineralogical understanding and artificial intelligence analysis of geochemical data according to an exemplary embodiment of the present disclosure can more accurately predict mineralization anomalies by utilizing both geochemical and physical exploration data to achieve a more comprehensive understanding of the subsurface. This integrated approach can be particularly effective in complex geological environments where a single data type model may miss important clues to mineralization.

In addition, the data process unit 112 may be configured to digitalize the geochemical data, the geologic spatial data and the physical exploration data.

In other words, the data process unit 112 may convert all of the data collected by the data collection unit 110 into a digital format that can be easily processed by a computer. For example, paper maps and records may be digitized, and geochemical measurements may be converted to a digital database.

The mapping unit 113 may be configured to map geologic and geochemical characteristics based on the geochemical data and the geologic spatial data using a geographic information system (GIS).

That is, the mapping unit 113 may be configured to visualize and analyze the spatial distribution of geologic features and geochemical signatures work by creating detailed maps with a geographic information system (GIS).

This may include creating raster maps (such as topographic maps made from elevation data) and vector maps (showing fault lines, large category geologic maps, pegmatite distribution and buffer maps, mine distribution maps, etc.).

In addition, the integration unit 114 may be configured to generate integrated data by integrating map data and data set; and a database configured to store the integrated data.

The integration unit 114 may combine all maps and data sets into a comprehensive database that can be used for analysis, maintaining relationships between different types of data and allowing them to be analyzed together.

In addition, as illustrated in FIG. 1, the model learning unit 130 may be configured to generate and learn an exploration mineral distribution anomaly model based on machine learning.

Here, the exploration mineral distribution anomaly model enables prediction of distribution anomaly based on geologic and ore deposit geological understanding of exploration mineral using the integrated data.

In addition, the model learning unit 130 may include a correlation analysis unit 131, a preprocess unit 132 and a learning unit 133.

The correlation analysis unit 131 may be configured to extract correlation information with the exploration mineral from the integrated data by statistical analysis.

The preprocess unit 132 may be configured to generate and preprocess model learning data based on the integrated data and the correlation information.

The learning unit 133 may be configured to learn an exploration mineral distribution anomaly model for predicting distribution anomaly of the exploration mineral using the model learning data.

In addition, the distribution anomaly prediction unit 150 may be configured to predict the distribution anomaly of the exploration minerals in the exploration region using the learned exploration mineral distribution anomaly model.

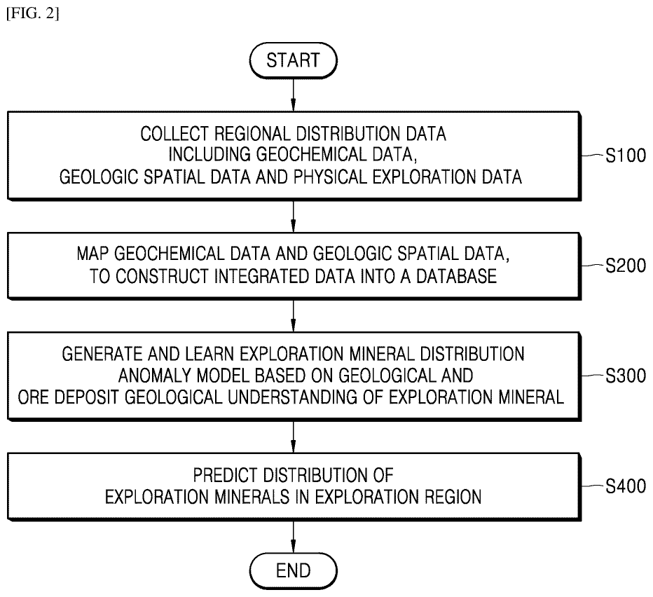

FIG. 2 is a flow chart illustrating a method for distribution anomaly prediction for new mineral exploration using mineralogical understanding and artificial intelligence analysis of geochemical data according to an exemplary embodiment of the present disclosure.

As illustrated in FIG. 2, the method for distribution anomaly prediction for new mineral exploration using mineralogical understanding and artificial intelligence analysis of geochemical data according to an exemplary embodiment of the present disclosure may include steps of: (a) collecting regional distribution data including pre-collected geochemical data and geologic spatial data of a region (S100); (b) mapping the geochemical data and the geologic spatial data, and integrating map data and data set to construct integrated data into a database (S200); (c) generating and learning an exploration mineral distribution anomaly model based on machine learning, wherein the exploration mineral distribution anomaly model enables prediction of distribution anomaly of exploration minerals in an exploration region using the integrated data (S300); and (d) predicting distribution of the exploration minerals in the exploration region using the learned exploration mineral distribution anomaly model (S400).

To be more specific, the step (a) (S100) may include collecting pre-collected geochemical data, geologic spatial data and physical exploration data of the region.

The step (b) (S200) may include mapping the geochemical data and the geologic spatial data, and integrating map data and data set to construct integrated data into a database.

Here, the step (b) (S200) may include steps of: (b1) digitalizing the geochemical data and the geologic spatial data; (b2) mapping geologic and geochemical characteristics based on the geochemical data and the geologic spatial data using a geographic information system (GIS); and (b3) constructing integrated data into a database by integrating map data and data set.

To be more specific, the step (b1) may be a step of data digitization, including converting all collected data into a digital format that can be easily processed by a computer. For example, paper maps and records may be digitized, and geochemical measurements may be converted to a digital database.

The step (b2) of mapping may include creating detailed maps using a geographic information system (GIS) to visualize and analyze the spatial distribution of geologic and geochemical features. This may include creating raster maps (such as topographic maps made from elevation data) and vector maps (showing fault lines, large category geologic maps, pegmatite distribution and buffer maps, mine distribution maps, etc.).

Here, the step (b2) may include an interpolation step, which may apply mathematical techniques such as inverse distance weighting (IDW) or Kriging to interpolate data points and generate a continuous surface map for a variable such as elemental concentration. This helps understanding the diffusion and concentration of elements in unmeasured areas.

The step (b3) may include combining and integrating all maps and data sets into a comprehensive database that can be used for analysis, such that relationships between different types of data can be maintained and analyzed together.

The integrated data may include geochemical threshold values calculated from the geochemical data by a method of statistical outlier extraction.

In addition, as illustrated in FIG. 2, the step (c) (S300) may include generating and learning an exploration mineral distribution anomaly model based on machine learning. Here, the exploration mineral distribution anomaly model enables prediction of distribution anomaly using the integrated data.

The step (c) (S300) may include steps of: (c1) extracting correlation information with the exploration mineral from the integrated data by statistical analysis; (c2) generating and preprocessing model learning data based on the integrated data and the correlation information; and (c3) learning an exploration mineral distribution anomaly model for predicting distribution anomaly of the exploration mineral using the model learning data.

To be more specific, in the step (c) (S300), once the spatial data is integrated and prepared, the next step may be performed to predict the location or distribution where the lithium anomaly is likely to be found. The step (c) (S300) may include processes as follows:
1) Feature selection: It is determine which data points (features) in the integrated data set are suitable for predicting exploration mineral (lithium) concentrations, which may include correlation information such as concentrations of exploration mineral elements, proximity to geological features, or topographical characteristics derived from topographic data. (Step (c1))
2) Data preprocessing: This is the step of cleaning and preprocessing the selected features to ensure that the AI model can receive high-quality and relevant data. This may include data scale normalization, missing value handling, etc. ((Step (c2))
3) Selecting or creating a model: This is the step of selecting or creating an appropriate AI algorithm or model that can handle the type of data and the specific prediction task. Depending on the complexity and nature of the data, common choices may include decision trees, random forests, stacking, support vector machines, and neural networks. (Step (c3))
4) Model training: This is the step where the pre-processed data is input to the AI model for training, which may include adjusting the parameters of the model to accurately predict exploration mineral (e.g., lithium) anomalies based on the input features. The model learns combinations of features that are likely to indicate the presence of exploration mineral (e.g., lithium) through patterns in the training data. (Step (c3))
5) Validating the model: In this step, the trained model is tested based on a separate set of data that was not used in the learning phase. This step is crucial to evaluate how well the model works and ensure that it can generalize its predictions to new, unseen data.

6) Refinement and iteration: This is the step of improving the model by tweaking settings, adding new features, or redesigning data preprocessing steps based on performance. This iterative process continues until the model achieves satisfactory accuracy and confidence.

In addition, the step (d) (S400) may include predicting distribution of the exploration minerals in the exploration region using the learned exploration mineral distribution anomaly model.

In addition, another exemplary embodiment of the present disclosure may include a computer program stored on a non-transitory medium for executing the method for distribution anomaly prediction for new mineral exploration using mineralogical understanding and artificial intelligence analysis of geochemical data.

Further, the program applicable to the method for distribution anomaly prediction for new mineral exploration using mineralogical understanding and artificial intelligence analysis of geochemical data according to an exemplary embodiment of the present disclosure may be implemented as computer-readable code on a computer-readable recording medium. The code and code segments implementing the above programs can be readily deduced by a computer programmer of ordinary skill in the art.

Here, a computer-readable recording medium may include any kind of recording device that stores data that can be read by a computer system. Examples of computer-readable recording media may include ROM, RAM, CD-ROM, magnetic tape, floppy disk, optical disk, and the like. Further, the computer-readable recording medium may be distributed across a networked computer system and may be written and executed as computer-readable code in a distributed manner.

Hereinafter, by applying the system 100 and method for distribution anomaly prediction for new mineral exploration using mineralogical understanding and artificial intelligence analysis of geochemical data according to an exemplary embodiment of the present disclosure, the process of predicting distribution anomaly of lithium minerals in pegmatite ore deposits will be described in detail with reference to the drawings.

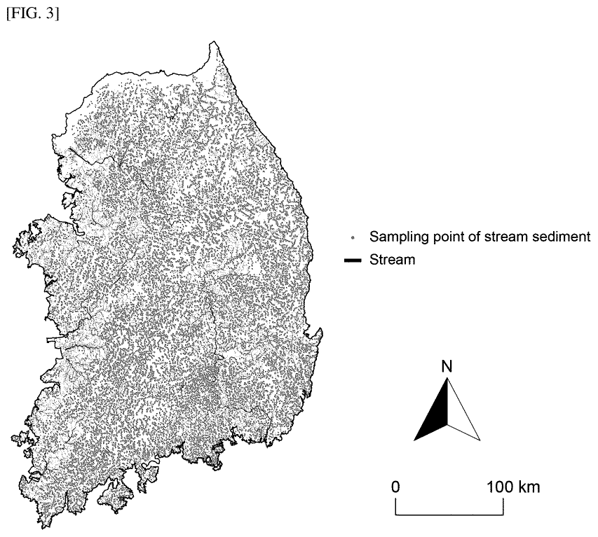

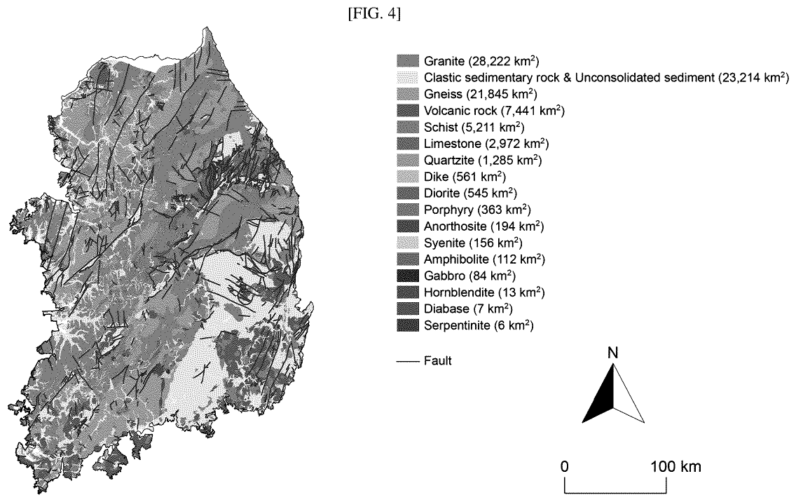

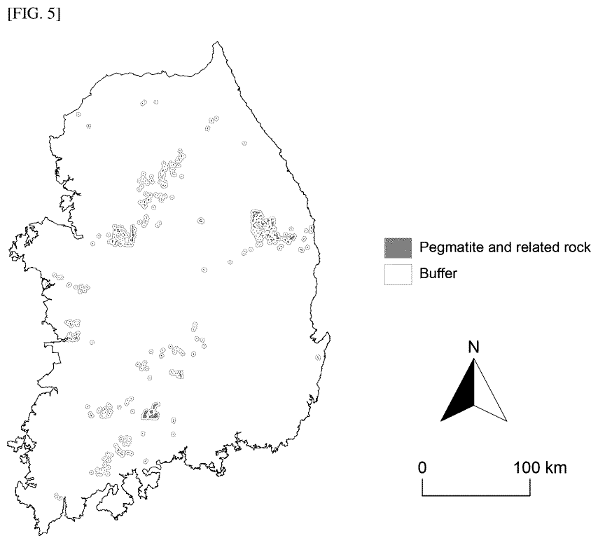

FIG. 3 is a map of sampling points of stream sediments and major water systems that are applied to a system for distribution anomaly prediction for new mineral exploration using mineralogical understanding and artificial intelligence analysis of geochemical data according to an exemplary embodiment of the present disclosure; FIG. 4 is a large category geologic map applied to a system for distribution anomaly prediction for new mineral exploration using mineralogical understanding and artificial intelligence analysis of geochemical data according to an exemplary embodiment of the present disclosure; and FIG. 5 is a pegmatite derivation and buffer map applied to a system for distribution anomaly prediction for new mineral exploration using mineralogical understanding and artificial intelligence analysis of geochemical data according to an exemplary embodiment of the present disclosure.

According to an exemplary embodiment of the present disclosure, as a development of the exploration technology, there are proposed the AI prediction system and method for predicting geologically deposited lithium anomalies (e.g., lithium-containing pegmatite) using geochemical data of the stream sediments.

For this purpose, the geochemical data (analysis data of 29 elements) from the stream sediment samples (N=23,094) collected throughout the inland (South Korea) may be utilized, as shown in FIG. 3.

Then, as shown in FIG. 4, the geologic maps of Korea Institute of Geology, Analysis, Mining & Meterials (KIGAM) at a scale of 1:250,000 may be utilized to create a large classification geologic map consisting of 17 lithofacies.

In other words, the large classification geologic map refers to a simplified 1:250,000-scale geologic map that reduces the complexity of rock types to just 17 types. This simplification can help focus the analysis on the important rock types that are relevant to the minerals desired to be explored, such as the rock types relevant to understanding lithium deposition properties.

In addition, as illustrated in FIG. 5, as a pegmatite derivation and buffer map, the pegmatite and relevant lithofacial polygon derivation and buffer map can be created from a nationwide 1:50,000-scale geologic map.

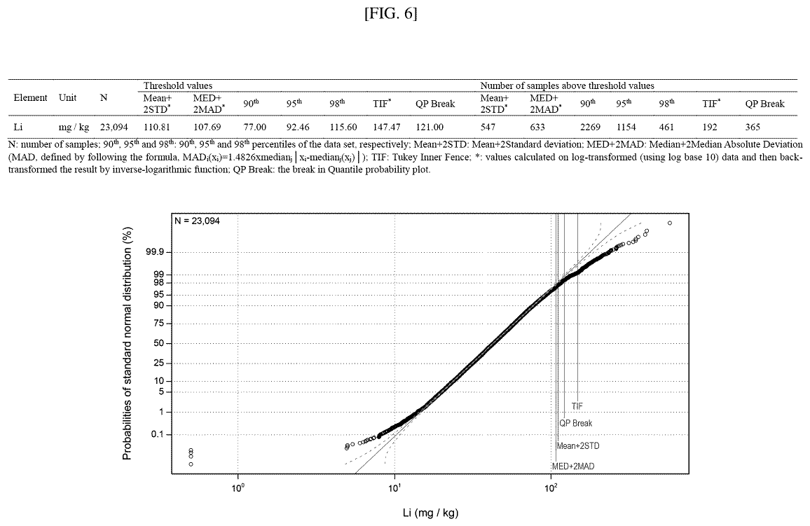

FIG. 6 is a derivation diagram of geochemical threshold values applied to a system 100 for distribution anomaly prediction for new mineral exploration using mineralogical understanding and artificial intelligence analysis of geochemical data according to an exemplary embodiment of the present disclosure.

As shown in FIG. 6, the lithium anomalies in stream sediments may be derived by considering geochemical thresholds (e.g., Mean+2SD, Median+2MAD, TIF, 90^{th}-95^{th}-98^{th} percentiles, QP Plot).

The graph shown in FIG. 6 plots the probability of a standard normal distribution (y-axis) versus lithium concentration (mg/kg) on a logarithmic scale (x-axis) (solid line indicates a normal distribution of lithium concentration).

Each threshold can create a potential cutoff point on the graph, above which concentrations are considered abnormal. This graph overlays these threshold values such that the amount of data above each of the threshold values can be visually assessed. The red areas highlight where significant anomalies begin based on these thresholds.

The threshold values may be used to filter geochemical data in order to focus on potential lithium anomalies. For example, concentrations above the 98^{th} percentile (115.6 mg/kg) are suggestive of areas with high potential for lithium-containing minerals, thus can be targeted for further investigation at the site.

This approach allows for the systematic identification and prioritization of lithium exploration areas, making the exploration process more efficient and targeted.

In addition, using multiple threshold values can help meet different levels of risk and potential in the exploration strategies.

In addition, [TABLE 1] below is a table showing geochemical data of 29 elements applied to the distribution anomaly prediction based on geologic and ore deposit geological understanding of exploration mineral for new mineral exploration using mineralogical understanding and artificial intelligence analysis of geochemical data according to an exemplary embodiment of the present disclosure.

TABLE 1

| Element | Unit | N | Min | 5^{th} | 10^{th} | 25^{th} | Median | 75^{th} | 90^{th} | 95^{th} | 98^{th} | Max | Mean | STD | p-value¹ | p-value² |
|---|---|---|---|---|---|---|---|---|---|---|---|---|---|---|---|---|
| SiO₂ | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| Fe₂O₃ | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| MgO | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| P₂O₅ | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| TiO₂ | wt. % | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| Li | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | [symbol] |
| [symbol] | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |
| Hf | mg/kg | [symbol] | [symbol] | [symbol] | [symbol] | [symbol] | [symbol] | [symbol] | [symbol] | [symbol] | [symbol] | [symbol] | [symbol] | [symbol] | <0.008 | <0.001 |

N: number of samples;
Min, Max and STD: minimum, maximum and standard deviation;
5^{th}, 10^{th}, 25^{th}, 75^{th}, 90^{th}, 95^{th} and 98^{th}: 5^{th}, 10^{th}, 25^{th}, 75^{th}, 90^{th}, 95^{th} and 98^{th} percentiles of the data set respectively;
¹results of Kolmogorov-Smirnov test for raw data of [symbol] elements.
²results of Kolmogorov-Smirnov test for log-transformed [symbol] of [symbol] elements.
Bold characters [symbol] is not satisfied. [symbol]
indicates data missing or illegible when filed

In the above, [TABLE 1] lists the measured chemical elements (e.g. Li, Cu, Zn) and their units of measurement (e.g., wt. %, mg/kg). N refers to the number of samples analyzed. Min, Max, and Mean respectively refer to the minimum, maximum, and average concentration values of each element for all samples.

The percentiles (5^{th}, 10^{th}, 25^{th}, 50^{th}, 75^{th}, 90^{th}, 95^{th}, and 98^{th} percentiles) show the distribution of elemental concentrations at various percentiles. They may be helpful for understanding how elemental concentrations are distributed within the sediment samples.

The standard deviation (STD) indicates the degree of variation or dispersion from the mean, while the p-value¹ and p-value² are the results of the Kolmogorov-Smirnov test for raw data and log-transformed data to verify the hypothesis that the data is normally distributed. Here, the p-value of less than 0.05 generally means that the distribution does not fit a normal distribution.

Based on the description above, it may be ascertained that the data shown in [TABLE 1] shows a significant variation in concentrations by element, and that many elements do not follow the normal distribution (p-value<0.05).

The percentiles are particularly important for identifying abnormal concentrations of elements. For example, concentrations above the 95^{th} or 98^{th} percentile can be considered anomalous. This can be useful when targeting areas for further explorations.

In addition, high concentration values of these elements may be associated with lithium-containing minerals or other types of mineral deposits.

Further, an exemplary embodiment of the present disclosure may use statistical tests, such as the Kolmogorov-Smirnov test, to help assess the suitability of the data for a normality-based model.

In addition, the AI models can also be trained to recognize patterns of elemental concentrations that correspond to known mineral deposits; by learning these patterns from elements in percentile distributions, the model can predict locations with similar geochemical features.

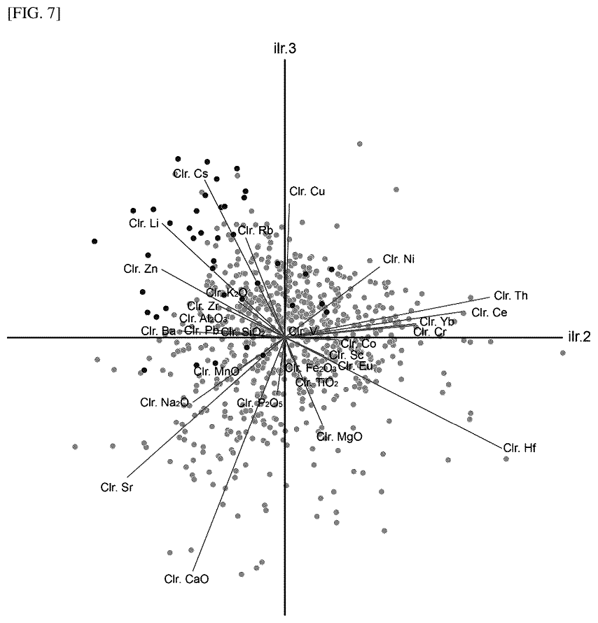

FIG. 7 is a graph illustrating principal component analysis (PCA) of geochemical data applied to a system 100 for distribution anomaly prediction for new mineral exploration using mineralogical understanding and artificial intelligence analysis of geochemical data according to an exemplary embodiment of the present disclosure.

FIG. 7 is a graph showing a biplot generated from a principal component analysis (PCA) of geochemical data consisting of 29 elements. The PCA is a statistical technique used to reduce the dimensionality of large data sets while preserving as much variability as possible.

As shown in FIG. 7, the scatter plot plots all samples by principal components, and the direction and magnitude of the vectors (lines pointing to the origin) indicate how each geochemical factor influences the distribution of samples in this PCA space.

Elements pointing in similar directions have similar effects on the sample distribution, and longer vectors indicate stronger correlation with the principal components. In addition, the spread of points indicates the diversity of geochemical composition across the sample.

In addition, as shown in FIG. 7, red points generally represent outliers or specific groups of interest, such as samples with high lithium concentrations, and highlighting these points can help visually assess distribution of these points and differences from the rest of the data.

By comparing the distribution of the red points to the rest of the data, it can be inferred whether a particular element (indicated by the direction of the vector) is characteristic of that sample.

The PCA can reduce the complexity of a data set by transforming many correlated variables (factors) into a smaller number of uncorrelated components, making it easier to visualize and analyze relationships.

In addition, the PCA can also help identify patterns, trends, and anomalies in the data, which can be important for mapping mineral deposits, understanding environmental impacts, or coordinating further geological exploration. In addition, as a tool for exploratory data analysis, the PCA can provide insights to guide more detailed statistical or machine learning analysis.

Moreover, through pattern analysis (e.g., Compositional PCA) of these constructed spatial data and stream sediment geochemical data, Label data can be constructed as supervised learning data for a lithium distribution anomaly prediction model of related ore depository (e.g., lithium-containing pegmatite).

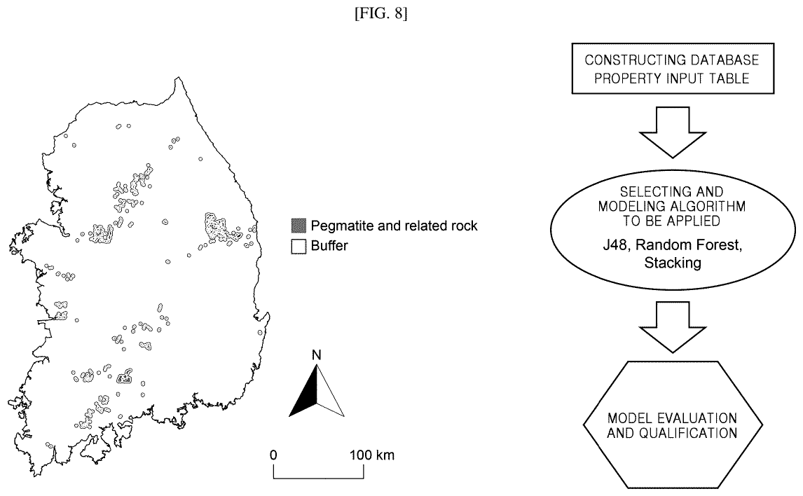

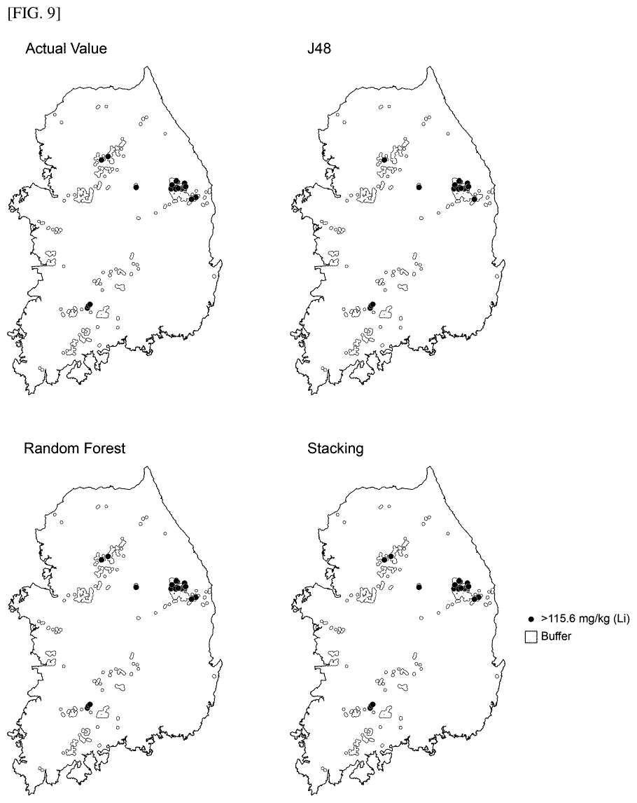

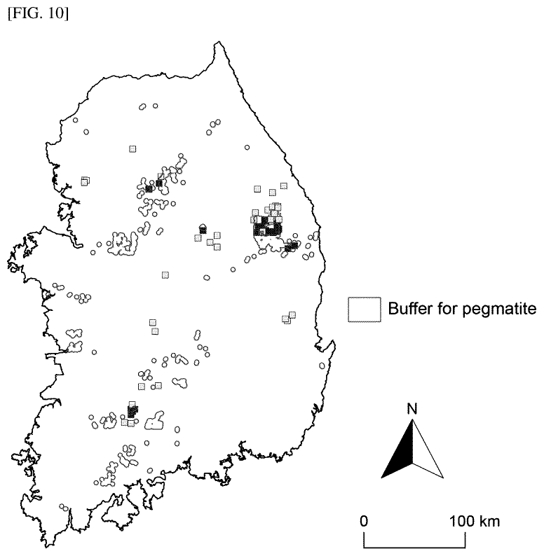

FIG. 8 is a diagram illustrating predictive modeling and validation process for lithium anomalies of pegmatite origin applied to a system for distribution anomaly prediction for new mineral exploration using mineralogical understanding and artificial intelligence analysis of geochemical data according to an exemplary embodiment of the present disclosure; and FIG. 9 and FIG. 10 are graphs illustrating results of the predictive modeling and validation process for lithium anomalies of pegmatite origin applied to a system for distribution anomaly prediction for new mineral exploration using mineralogical understanding and artificial intelligence analysis of geochemical data according to an exemplary embodiment of the present disclosure.

As shown in FIG. 8, a property input table of the database (DB) 115 may be constructed to generate and build a machine learning data set through integration of geochemical data and geologic spatial data and correlation analysis such as PCA analysis.

In addition, the models such as J48, Random Forest, and Stacking may be built and applied to the AI models for predicting distribution anomaly of exploration minerals. These models can be learned through the training data set as described above.

In other words, the selection of artificial intelligence algorithms or models for the application of supervised learning data construction may include the selection of algorithms based on decision trees and logistic that can be applied to stream sediment's geochemical data that do not follow the normal distribution. In addition, models for optimal combination (e.g., ensemble, stacking, etc.) may be selected.

After learning the model by using the learning data set in the database (DB) 115, the performance of the model can be tested. That is, once the learning is complete, the model's performance can be evaluated using a separate data set that was not used in the learning phase. This testing may be performed to ensure that the model can accurately predict lithium anomalies under different conditions.

Then, based on performance metrics, the model can be refined and relearned to improve accuracy and reduce false positives or false negatives.

The trained AI model can then be used to predict lithium anomaly (distribution anomaly) in untested exploration areas. This application can greatly support targeted exploration efforts, reducing the time and cost associated with physical exploration.

In addition, as new data becomes available, the models can be updated to refine predictions and adapt to new discoveries or changes in geologic understanding.

As shown in FIG. 9 and FIG. 10, the results of predicting lithium anomalies of pegmatite origin using the above prediction models clearly show that the model performance improves as it goes to the stacking model. In addition, it is clearly shown that the stacking model can detect the lithium anomalies of pegmatite origin with significantly better performance (Li, 98th 115.6 (mg/kg) as the geochemical threshold value).

As described above, the system 100 and method for distribution anomaly prediction for new mineral exploration using mineralogical understanding and artificial intelligence analysis of geochemical data according to an exemplary embodiment of the present disclosure have the following advantages:
1) Improved prediction accuracy: The system according to an exemplary embodiment of the present disclosure can integrate geochemical data and mineralogical insights to predict the location of mineral deposits more accurately.

In addition, these systems and methods according to an exemplary embodiment of the present disclosure allow for more targeted exploration, which reduces the area that needs to be physically surveyed, minimizing the cost and time spent on discovery.
2) Cost-effectiveness: Exploring for minerals using traditional methods can be costly, especially in remote or inaccessible areas. The prediction models based on geochemical and mineralogical data can significantly narrow down the areas of interest before conducting costly drilling or detailed field surveys.

Thus, the system and method according to an exemplary embodiment of the present disclosure can be more cost-effective in that resources can be allocated more efficiently to focus efforts and investments in areas that are likely to contain economically viable mineral deposits.
3) Reducing environmental impacts: The system according to an exemplary embodiment of the present disclosure has the advantage that fewer areas need to be disturbed by drilling and sampling, which is particularly important in ecologically sensitive or protected areas, and by reducing the extent and intensity of ground disturbance, the exploration companies can better comply with environmental regulations and protect biodiversity.
4) In-depth geologic insights: The system that integrates geochemical data and mineralogical understanding can provide deep insights into the geologic processes underway in a given area.

This can help to understand not only the presence of specific minerals, but also the geologic history of the site, including rock formation, alteration, and erosion processes, and this comprehensive understanding can help guide further exploration and assess mining potential and risks.
5) Leverage advanced technology: When analyzing complex data sets, AI and machine learning algorithms offer the potential to identify patterns and correlations that may be invisible to human analysts. The AI and machine learning algorithms can also process massive amounts of data quickly and precisely, and can continuously learn and improve with additional data inputs to refine prediction models over time to increase accuracy of the prediction.
6) Multi-source data integration: An effective anomaly prediction system can integrate multiple data sources, not only geochemical and mineralogical data, but also physical exploration data such as seismic and radiometric data, and spatial data from GIS platforms, which can improve the robustness of the model.

This multi-layered analysis can improve the reliability of forecasts by providing a holistic view of the subsurface.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

100: distribution anomaly prediction system
110: database development unit
111: data collection unit
112: data process unit
113: mapping unit
114: integration unit
115: database (DB)
130: model learning unit
131: correlation analysis unit
132: preprocess unit
133: learning unit
150: distribution anomaly prediction unit

What is claimed is:

1. A system for distribution anomaly prediction for new mineral exploration using mineralogical understanding and artificial intelligence analysis of geochemical data, the system comprising:
a database development unit configured to collect regional distribution data including pre-collected geochemical data and geologic spatial data of a region and to integrate map data and data set to construct integrated data into a database;
a model learning unit configured to generate and learn an exploration mineral distribution anomaly model based on machine learning, wherein the exploration mineral distribution anomaly model enables prediction of distribution anomaly based on geologic and ore deposit geological understanding of exploration mineral using the integrated data; and
a distribution anomaly prediction unit configured to predict the distribution anomaly of the exploration minerals in an exploration region using the learned exploration mineral distribution anomaly model.

2. The system of claim 1,
wherein the geologic spatial data includes at least one of raster topographic analysis information, raster and vector data extracted grid information, fault buffer map information, large classification geologic map information, potential embedment medium buffer map information of exploration mineral, or a combination thereof.

3. The system of claim 1,
wherein the database development unit includes:
a data collection unit configured to collect regional distribution data including pre-collected geochemical data, geologic spatial data and physical exploration data of a region;
a data process unit configured to digitalize the geochemical data, the geologic spatial data and the physical exploration data;
a mapping unit configured to map geologic and geochemical characteristics based on the geochemical data and the geologic spatial data using a geographic information system (GIS);
an integration unit configured to generate integrated data by integrating map data and data set; and
a database configured to store the integrated data.

4. The system of claim 1,
wherein the model learning unit includes:
a correlation analysis unit configured to extract correlation information with the exploration mineral from the integrated data by statistical analysis;
a preprocess unit configured to generate and preprocess model learning data based on the integrated data and the correlation information; and
a learning unit configured to learn an exploration mineral distribution anomaly model for predicting distribution anomaly of the exploration mineral using the model learning data.

5. A method for distribution anomaly prediction for new mineral exploration using mineralogical understanding and artificial intelligence analysis of geochemical data, the method comprising steps of:
(a) collecting regional distribution data including pre-collected geochemical data and geologic spatial data of a region;
(b) mapping the geochemical data and the geologic spatial data, and integrating map data and data set to construct integrated data into a database;
(c) generating and learning an exploration mineral distribution anomaly model based on machine learning, wherein the exploration mineral distribution anomaly model enables prediction of distribution anomaly based on geologic and ore deposit geological understanding of exploration mineral using the integrated data; and
(d) predicting distribution of the exploration minerals in an exploration region using the learned exploration mineral distribution anomaly model.

6. The method of claim 5,
wherein the geochemical data includes geochemical data of at least one of Al₂O₃, SiO₂, Fe₂O₃, CaO, Na₂O, K₂O, MgO, P₂O₅, MnO, TiO₂, Ba, Cu, Li, Ni, Pb, Sr, V, Zr, Co, Cr, Rb, Zn, Ce, Cs, Sc, Eu, Yb, Th, Hf, or a combination thereof, as components of a stream sediment.

7. The method of claim 5,
wherein the geologic spatial data includes at least one of raster topographic analysis information, raster and vector data extracted grid information, fault buffer map information, large classification geologic map information, potential embedment medium buffer map information of exploration mineral, or a combination thereof.

8. The method of claim 5,
wherein the step (b) includes steps of:
(b1) digitalizing the geochemical data and the geologic spatial data;
(b2) mapping geologic and geochemical characteristics based on the geochemical data and the geologic spatial data using a geographic information system (GIS); and
(b3) constructing integrated data into a database by integrating map data and data set.

9. The method of claim 5,
wherein the step (c) includes steps of:
(c1) extracting correlation information with the exploration mineral from the integrated data by statistical analysis;
(c2) generating and preprocessing model learning data based on the integrated data and the correlation information; and
(c3) learning an exploration mineral distribution anomaly model for predicting distribution anomaly of the exploration mineral using the model learning data.

10. The method of claim 5,
wherein the integrated data includes a geochemical threshold value calculated from the geochemical data by a method of statistical outlier extraction.
